(19) United States
(12) Patent Application Publication
(10) Pub. No.: US 2005/0129807 A1
(43) Pub. Date: Jun. 16, 2005

(54) Method and process of preserving alcoholic and carbonated beverage

(76) Inventors: James T. C. Yuan, Naperville, IL (US); Henry Ledon, Versailles (FR)

Correspondence Address: AIR LIQUIDE, 2700 POST OAK BOULEVARD, SUITE 1800, HOUSTON, TX, 77056, US

(21) Appl. No.: 10/971,917

(22) Filed: Oct. 22, 2004

Related U.S. Application Data
(60) Provisional application No. 60/529,362, filed on Dec. 12, 2003.

(51) Int. Cl. C12G 1/00

(52) U.S. Cl. 426/8

(57) ABSTRACT

This disclosure discusses methods of preserving and carbonating beverages. The invention provides a method of injecting carbon dioxide containing gas into a liquid, such as a carbonated alcoholic beverage or beer, to obtain a first pressure, which is held constant for a desired length of time. The pressure is then reduced to a final second pressure, whereby retaining a sufficient level of carbon dioxide in the liquid. The carbon dioxide containing gas may be carbon dioxide or mixtures of carbon dioxide and an inert gas. The desired effects include reduction in beer spoilage microorganisms, reduction of dissolved oxygen in the liquid, inhibition of enzymes in the stored liquid, and being able to obtain a target level of dissolved gas in the liquid.

### CROSS-REFERENCE

This application claims the benefit of U.S. Provisional Application No. 60/529,362, filed Dec. 12, 2003, the entire contents of which are incorporated herein by reference.

### BACKGROUND

Special problems exist in the manufacturing of certain alcoholic and carbonated beverages. For example, beer is a thin fermented gruel made of mashed sprouted grain or malt. During fermentation, yeast acts on the simple sugars that are released by the enzymatic breakdown of this malt. These yeasts greatly enhance the nutritional properties of this drink. The yeast produces carbon dioxide, which results in an anaerobic environment, which is ideal for lactic acid bacteria growth. These bacteria contribute to the fermentation, and produce an acidic condition in the beer. These bacteria further add to the nutritional value in the form of protein, amino acids and vitamins. Whereas the unfermented drink may have had 1-2% protein content, the resulting fermented drink may have 8-20% protein.

The acid condition formed by the lactic acid bacteria, in addition to the presence of dissolved carbon dioxide gas, create an environment that tends to inhibit the growth of microorganisms. This results in a hearty, nutritious beverage that is naturally preserved, and can be kept in storage for months.

Despite this somewhat mild natural preservation quality of beer, microorganisms causing spoilage during brewing and beer processing are the main problem to the beer industry. The microbial spoilage of beer is limited to a few genera of bacteria, wild yeasts, and molds. This is because, as mentioned above, beer is a rather unfavorable growth medium for most beer spoilage microorganisms. The alcohol content, low pH, and the presence of hop constituents are inhibitory, while the lack of nutrients restricts growth of those cells, which do survive. Nevertheless, these microorganisms can interfere with fermentation or have deleterious effects on beer flavor and shelf life. One common process of removing unwanted microorganisms during beer brewing is using filtration.

To be acceptable for use in the sterile filtration of beer, membranes must be demonstrably capable of consistently removing all spoilage microorganisms. It is customary to test such membranes by filtering a suspension of spoilage microorganisms and then carrying out a microbiological analysis of the filtrate to determine whether any cells passed through the filter and, if so, how many. The problem is that the variable cell size and difficulty of obtaining high densities of common species of beer spoilage bacteria (especially those in the genus Lactobacillus) make it almost impossible to achieve the necessary reproducibility.

The next major process which takes place after filtration and prior to packaging is carbonation. Carbon dioxide not only contributes to perceived “fullness” or “body” and enhances foaming potential; it also acts as a flavor enhancer and plays an important role in extending the shelf life of the product. The level of dissolved carbon dioxide in beer following primary fermentation varies as a result of a number of parameters such as temperature, pressure, yeast, type of fermentation vessel, and initial wort clarity. Typically, carbon dioxide levels range from 1.2 to 1.7 volumes of carbon dioxide per volume of beer (v/v) for non-pressurized fermentations. Consequently, carbon dioxide levels need adjustment after the fermentation stage, unless the beer has undergone a traditional lagering.

The common practice is to raise the carbon dioxide level between 2.2 and 2.8 v/v prior to packaging through carbonation process. The amount of carbonation lost during bottle filling is heavily influenced by the carbonation level of that particular beer. Highly carbonated beers lose more carbonation when bottled compared to beers with lower levels of carbonation. Practically, beer will begin to seem flat when the carbonation level drops to around 2.2 volumes. Too much carbonation is not desirable either as highly carbonated beers have a “CO₂ burn”. This burn is a sensation that is felt throughout the mouth. Overall, beer carbonation is important and should be controlled as carefully as other characteristics, including original gravity, bitterness, and color.

Another real issue to consider when bottling beer is oxygen pick-up. The rule of thumb in a commercial brewery is that oxygen pick-up becomes increasingly more important as the beer nears completion. Beer transfers, following the fermentation, filtration, and packaging process steps, are three areas in which careful attention is required with respect to oxygen pick-up.

For the foregoing reasons, there is a need for a process that will effectively kill beer spoilage microorganisms. There is also a need for a process that will allow an extended shelf life of the treated beer, by inhibiting enzymes that will temper the taste of the beer during storage. There is also a need for a process that will provide a carbon dioxide source so that the beverage can maintain a proper level of carbonation, while simultaneously effectively removing dissolved oxygen in the beverage to improve quality during storage.

### SUMMARY

The present invention is directed to a method that satisfies the need for a process that will effectively kill beer spoilage microorganisms. The present invention is also directed to a process that will allow an extended shelf life of the treated beer, by inhibiting enzymes that will affect the taste of the beer during storage. The present invention is also directed to a process that will provide a carbon dioxide source so that the beverage can maintain a proper level of carbonation, while simultaneously effectively removing dissolved oxygen in the beverage to improve quality during storage.

This method involves injecting sufficient carbon dioxide containing gas into a liquid to obtain a first predetermined pressure. This first pressure is maintained for a predetermined amount of time, which is sufficient to obtain a first desired effect. This pressure is then controlled in such a fashion as to obtain a second predetermined pressure. This second pressure is sufficient to allow a portion of the carbon dioxide containing gas to be released from the liquid, wherein sufficient carbon dioxide is retained in the liquid to obtain a second desired effect.

The liquid may be a carbonated alcoholic liquid, such as beer. The carbon dioxide containing gas may be carbon dioxide or mixtures of carbon dioxide and an inert gas. The inert gas may be nitrogen, argon, krypton, xenon, or neon. This inert gas may comprise between about 0% to about 90%, by volume, of the carbon dioxide containing gas. This inert gas may comprise between about 10% to about 70%, by volume, of the carbon dioxide containing gas.

The carbon dioxide containing gas may be injected into the liquid by means of a membrane, sparger, infuser, static mixer, or injector. This first pressure can be between about 500 psi and about 2500 psi.

The first, or second, desired effect is the reduction in beer spoilage microorganisms, the reduction of dissolved oxygen in the liquid, the inhibition of enzymes in the stored liquid, or the obtainment of a predetermined level of dissolved gas in the liquid.

The predetermined level of dissolved gas in the liquid may be between about 2 volumes of carbon dioxide and about 4 volumes of carbon dioxide. The predetermined level of dissolved gas in the liquid may be between about 2.2 volumes of carbon dioxide and about 2.5 volumes of carbon dioxide. The second pressure may be between about 1 atmosphere and about 30 psig. The second pressure may be between about 10 psig and about 15 psig. The temperature of this method may be between about 0° C. and about 70° C.

### BRIEF DESCRIPTION OF DRAWINGS

For a further understanding of the nature and objects of the present invention, reference should be made to the following detailed description, taken in conjunction with the accompanying drawings, in which like elements are given the same or analogous reference numbers and wherein:

FIG. 1 illustrates a method for carbonating a liquid in accordance with one embodiment of the invention.

FIG. 2 illustrates an embodiment where flow control means 103 is opened and the carbon dioxide containing gas is introduced into the liquid through injection means 102.

FIG. 3 illustrates another embodiment where flow control means 105 is opened to allow a portion of the carbon dioxide containing gas to be released from the liquid and to escape vessel 100.

FIG. 4 illustrates an embodiment where flow control means 105 may be closed to maintain the second pressure; and

FIG. 5 illustrates an embodiment where some or all of the carbon dioxide containing gas may be recycled.

### DESCRIPTION

The present invention is directed to a method that satisfies the need for a process that will effectively kill beer spoilage microorganisms. The present invention is also directed to a process that will allow an extended shelf life of the treated beer, by inhibiting enzymes that will affect the taste of the beer during storage. The present invention is also directed to a process that will provide a carbon dioxide source so that the beverage can maintain a proper level of carbonation, while simultaneously effectively removing dissolved oxygen in the beverage to improve quality during storage.

This method involves injecting sufficient carbon dioxide containing gas into a liquid to obtain a first predetermined pressure. This first pressure is maintained for a predetermined amount of time, which is sufficient to obtain a first desired effect. This pressure is then controlled in such a fashion as to obtain a second predetermined pressure. This second pressure is sufficient to allow a portion of the carbon dioxide containing gas to be released from the liquid, and where by sufficient carbon dioxide is retained in the liquid to obtain a second desired effect.

This liquid may be a carbonated alcoholic liquid, such as beer. The carbon dioxide containing gas may be chosen from the following group; carbon dioxide, or a mixture of carbon dioxide and an inert gas. This inert gas may be chosen from the following group; nitrogen, argon, krypton, xenon, or neon. This inert gas may comprise between about 0% to about 90%, by volume, of the carbon dioxide containing gas. This inert gas may comprise between about 10% to about 70%, by volume, of the carbon dioxide containing gas.

This carbon dioxide containing gas may be injected into the liquid by means of a membrane, sparger, infuser, static mixer, or injector. This first pressure can be between about 500 psi and about 2500 psi.

The first, or second, desired effect may be the reduction in beer spoilage microorganisms. The first, or second, desired effect may be the reduction of dissolved oxygen in the liquid. The first, or second, desired effect may be the inhibition of enzymes in the stored liquid. The first, or second, desired effect may be to obtain a predetermined level of dissolved gas in the liquid.

The predetermined level of dissolved gas in the liquid may be between about 2 volumes of carbon dioxide and about 4 volumes of carbon dioxide. The predetermined level of dissolved gas in the liquid may be between about 2.2 volumes of carbon dioxide and about 2.5 volumes of carbon dioxide. The second pressure may be between about 1 atmosphere and about 30 psig. The second pressure may be between about 10 psig and about 15 psig. The temperature of this method may be between about 0° C. and about 70° C.

The invention provides a carbon dioxide source to a liquid in order to maintain a desired level of carbonation. The invention introduces sufficient quantity of a carbon dioxide containing gas into a liquid in order to obtain a first predetermined pressure. This first pressure is maintained for a period of time sufficient to achieve a first desired effect. The pressure is then controlled in such a way as to allow a portion of the carbon dioxide containing gas to be released, thereby obtaining a second predetermined pressure. This results in the gas retaining sufficient carbon dioxide containing gas to achieve a second desired effect.

The invention is illustrated with the example of a carbonated alcoholic beverage, but should not be interpreted as being limited only to this purpose.

After fermenting, the carbonated alcoholic beverage will begin to lose the dissolved carbon dioxide. If maintained at atmospheric pressure, this beverage will ultimately become completely non-carbonated. In fact, many commercial breweries remove carbon dioxide by vacuum, to be used at a point later in the process. This exposes the freshly fermented beer to a host of microorganisms, dissolved oxygen and enzymes that may have a negative effect on the overall quality of the beverage. Also, after fermenting is complete, carbon dioxide is typically lost from the beverage during the filtration and conditioning steps. Typically in commercial breweries, as the fermented beer is transported to the bottling stage, it is also loses carbonation.

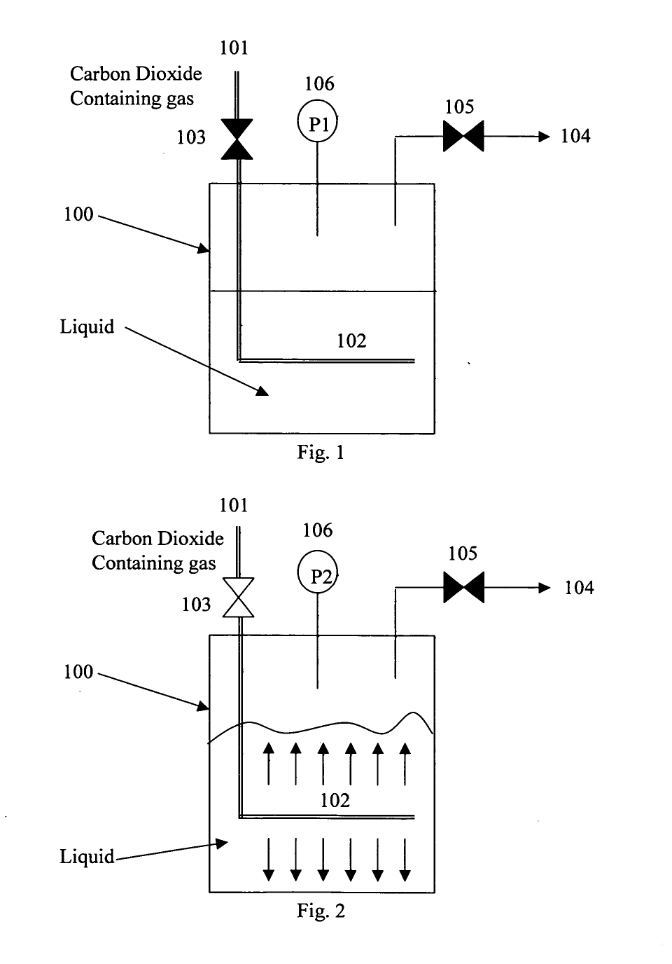

Turning now to FIG. 1, a method for carbonating a liquid in accordance with the embodiment of the present invention is illustrated. The fermented, carbonated alcoholic beverage, having a reduced carbon dioxide level as described above, is introduced into vessel 100. Vessel 100 comprises at least an inlet conduit 101 for introducing a carbon dioxide containing gas, an outlet conduit 104, and a pressure monitoring means 106. Inlet conduit 101 further comprises at least an injection means 102 and a flow control means 103. Outlet conduit 104 further comprises at least a flow control means 105.

Injection means 102 may comprise a membrane, a sparger, an infuser, a nozzle, a static mixer or an injector. Injection means 102 may be any device known to one skilled in the art that would allow the properly homogeneous distribution of the dissolved carbon dioxide containing gas. In a preferred embodiment, injection means 102 comprises non-polypropylene membranes.

Note that a polypropylene fiber membrane will not be appropriate for this service, as the membrane will ‘wet out’ almost immediately. A membrane “wets out” when liquids fill the membrane pores and create a liquid pathway through the membrane, thereby rendering the entire system ineffective.

Turning to FIG. 2, flow control means 103 is opened and the carbon dioxide containing gas is introduced into the liquid through injection means 102. The carbon dioxide containing gas is injected at a moderate pressure. The moderate pressure may be between about 500 psi and about 2500 psi. In a preferred embodiment the moderate pressure may be between about 800 psi and about 1500 psi. Typical commercial High Pressure Processing (HPP) systems use a much higher injection pressure, typically above 10,000 psi. This high pressure leads to conditions that may create unfavorable products with the current state-of-the-art processes.

A first predetermined pressure, P1, is thus achieved throughout vessel 100. The first pressure is maintained for a predetermined period of time to achieve a first desired effect. The first desired effect may be one or more of the following: the reduction of beer spoilage microorganisms, the reduction of dissolved oxygen in the liquid, the inhibition of enzymes in the stored liquid, or achieving a predetermined level of dissolved gas in the liquid. In a preferred embodiment the first desired effect is to allow the beer spoilage microorganisms to be killed. In another preferred embodiment the first desired effect is the inhibition of various undesirable enzymes.

Dissolved oxygen is also being removed from the beverage at this time, and carbon dioxide is, in turn, being dissolved into the liquid. The predetermined time may be between about 6 seconds and about 60 minutes. The predetermined period of time is easily determined by the skilled artisan without undue experimentation, and is dependent on the desired first effect.

The carbon dioxide containing gas may be pure carbon dioxide gas, or a mixture of carbon dioxide gas and an inert gas. The inert gas may be nitrogen, argon, krypton, xenon, neon or any combination thereof. The inert gas may account for from about 0% to about 100% of the volume of the carbon dioxide containing gas. In another embodiment, the inert gas may account to from 0% to about 90% of the volume of the carbon dioxide containing gas. In a preferred embodiment, the inert gas may account for from about 10% to about 70% of the volume of the carbon dioxide containing gas.

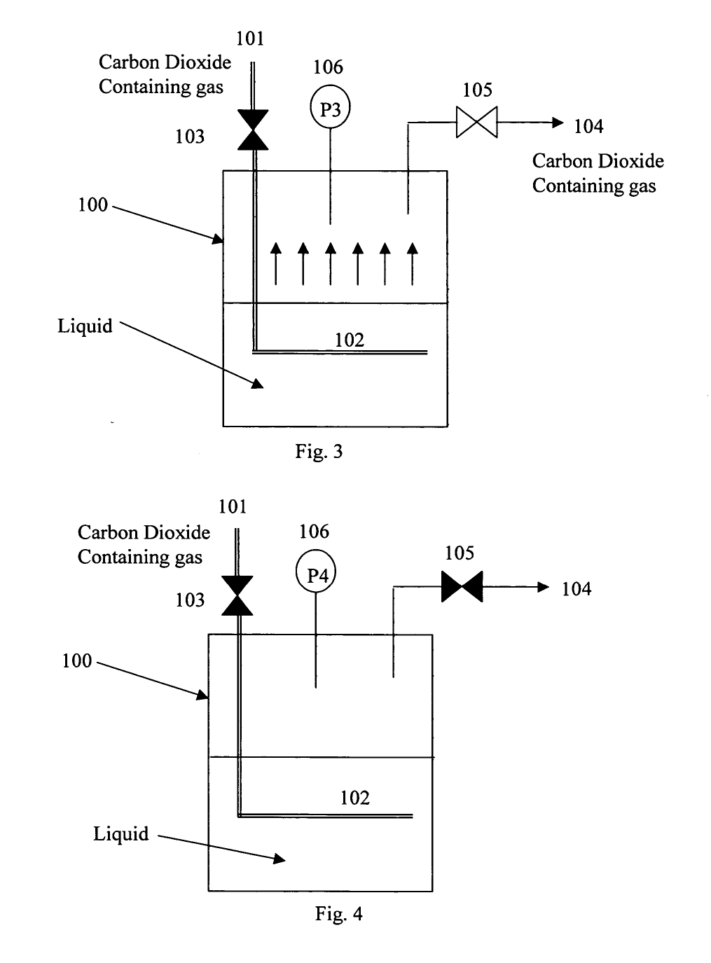

Turning to FIG. 3, flow control means 103 is closed, and flow control means 105 is opened to allow a portion of the carbon dioxide containing gas to be released from the liquid and to escape vessel 100. Thus, after the predetermined time period has expired, the first pressure, P1, is reduced to a second predetermined pressure, P2. This will allow any released oxygen, as well as a portion of the carbon dioxide containing gas, to be released from the headspace of vessel 100.

Turning to FIG. 4, flow control means 105 may be closed to maintain the second pressure. In an alternate embodiment, flow control means 105 may remain open if the system upstream of flow control means 105 is maintained at the second pressure. The second pressure is thus achieved throughout vessel 100.

The second pressure is maintained for a predetermined period of time to achieve a second desired effect. The second desired effect may be one or more of the following: the reduction of beer spoilage microorganisms, the reduction of dissolved oxygen in the liquid, the inhibition of enzymes in the stored liquid, or achieving a predetermined level of dissolved gas in the liquid. In a preferred embodiment, the second desired effect is to allow the beer spoilage microorganisms to be killed. In another preferred embodiment, the second desired effect is the inhibition of various undesirable enzymes. In another preferred embodiment, the second desired effect is to achieve a predetermined level of dissolved gas in the liquid.

In water (the primary constituent of any beverage) carbon dioxide is 73 times as soluble as nitrogen, 32 times as soluble as argon, 17 times as soluble as krypton, 8 times as soluble as Xenon, and 122 times as soluble as neon. Therefore, virtually all of the inert gases will escape at this time, while the carbon dioxide will remain dissolved.

The second pressure may be sufficient to maintain between 2 and 4 volumes of carbon dioxide in the beverage. In one embodiment, the second pressure may be from about zero psig (1 atmosphere) and about 500 psig. In another embodiment, the second pressure may be between about 10 psig and about 15 psig. The second pressure is sufficient to maintain an acceptable level of carbonation in the packaged beverage, after the inevitable loss of carbon dioxide during the bottling process.

In a preferred embodiment, the second pressure is sufficient to result in a dissolved level of gas that is between about 2.2 volumes of CO₂ and about 2.5 volumes of CO₂. In a preferred embodiment, the method is performed at a temperature that ranges from about 0° C. to about 70° C.

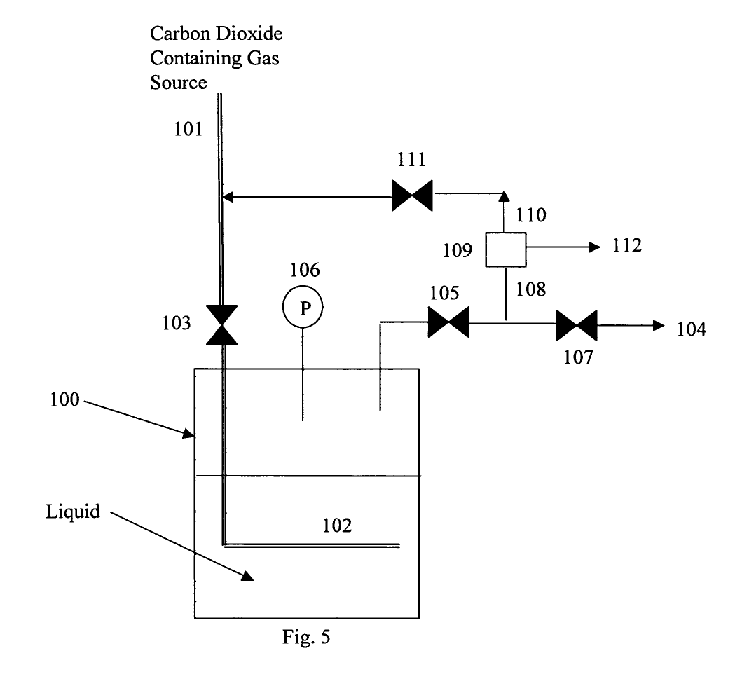

Turning to FIG. 5, some or all of the carbon dioxide containing gas that leaves vessel 100 may be recycled. When flow control means 105 is opened to allow carbon dioxide containing gas to be released from the liquid and to escape from vessel 100, valve 107 may be modulated to allow some or all of the gas to be diverted to a recycle circuit. The recycle circuit comprises at least a discharge conduit 112 and a recycle conduit 110.

The recycle circuit may also contain a separation means 109. The separation means 109 may comprise separation media (such as membranes or filters), solid or liquid adsorbents, a catalyst or a scrubber. Separation means 109 may be any device known to one skilled in the art that would allow the properly separation of the desired gas from the undesired gas that is present in outlet conduit 104.

Sensors may be located in one or more of outlet conduit 104, separation means 109, recycle conduit 110, discharge conduit 112. These sensors may be designed to detect the quality of the gas to be recycled. Sensors of this type are well known to those of skill in the art.

Once it is determined that the gas to be recycled is of sufficient quality, recycle valve 111 may be opened to allow the gas to flow back to, and combine with, the carbon dioxide containing gas entering the system by way of inlet conduit 101.

Illustrative embodiments of the invention are described below. While the invention is susceptible to various modifications and alternative forms, specific embodiments thereof are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The invention is not limited to the preferred embodiments described above, but rather defined by the claims set forth below.

1. A method of treating a liquid, the method comprising:
a) introducing a liquid into a vessel, wherein said vessel's pressure is controlled,
b) injecting a carbon dioxide containing gas into said liquid to obtain a first predetermined pressure in said vessel,
c) maintaining said first predetermined pressure for a predetermined period of time, wherein said predetermined time is effective to obtain a first desired effect,
d) controlling said vessel's pressure to obtain a second predetermined pressure, sufficient to allow a portion of the carbon dioxide containing gas to be released from the liquid, and
e) retaining sufficient carbon dioxide containing gas to obtain a second desired effect.

2. The method of claim 1, wherein said liquid is a carbonated alcoholic liquid.

3. The method of claim 2, wherein said carbonated alcoholic liquid is beer.

4. The method of claim 1, wherein said carbon dioxide containing gas is selected from the group consisting of carbon dioxide and mixtures of carbon dioxide and an inert gas.

5. The method of claim 4, wherein said inert gas is selected from the group consisting of nitrogen, argon, krypton, xenon, neon, or any combination thereof.

6. The method of claim 5, wherein said inert gas comprises between about 0% and about 100%, by volume, of the carbon dioxide containing gas.

7. The method of claim 2, wherein said inert gas comprises between about 0% and about 90%, by volume, of the carbon dioxide containing gas.

8. The method of claim 6, wherein said inert gas comprises between about 10% and about 70%, by volume, of the carbon dioxide containing gas.

9. The method of claim 1, wherein said gas injection is accomplished by means selected from the group consisting of membrane, sparger, infuser, nozzle, static mixer, or injector.

10. The method of claim 1, wherein said first pressure is between about 500 psi and about 2500 psi.

11. The method of claim 10, wherein said first pressure is between about 800 psi and about 1500 psi.

12. The method of claim 1, wherein said predetermined time period is between about 6 seconds and about 60 minutes.

13. The method of claim 1, wherein said first desired effect is the reduction in beer spoilage microorganisms.

14. The method of claim 1, wherein said first desired effect is the reduction of dissolved oxygen in the liquid.

15. The method of claim 1, wherein said first desired effect is the inhibition of enzymes in the stored liquid.

16. The method of claim 1, wherein said first desired effect is to obtain a predetermined level of dissolved gas in the liquid.

17. The method of claim 16, wherein said predetermined level of dissolved gas is between about 2 volumes of CO₂ to about 4 volumes of CO₂.

18. The method of claim 17, wherein said predetermined level of dissolved gas is between about 2.2 volumes of CO₂ and about 2.5 volumes of CO₂.

19. The method of claim 1, wherein said second pressure is from about 0 psig up to about 500 psig.

20. The method of claim 18, wherein said second pressure is from about 10 psig up to about 15 psig.

21. The method of claim 1, wherein said second desired effect is the reduction of dissolved oxygen in the liquid.

22. The method of claim 1, wherein said second desired effect is the inhibition of enzymes in the stored liquid.

23. The method of claim 1, wherein said second desired effect is to obtain a predetermined level of dissolved gas in the liquid.

24. The method of claim 23, wherein said predetermined level of dissolved gas is between about 2 volumes of CO₂ to about 4 volumes of CO₂.

25. The method of claim 23, wherein said predetermined level of dissolved gas is between about 2.2 volumes of CO₂ and about 2.5 volumes of CO₂.

26. The method of claim 1, further comprising maintaining the temperature of said method at about 0° C. to about 70° C.

27. The method of claim 1, wherein said released portion of the carbon dioxide containing gas is recycled.
